(19) United States
(12) Patent Application Publication
(10) Pub. No.: US 2018/0199549 A1
(43) Pub. Date: Jul. 19, 2018

(54) Hygienic nesting Cavity for Birds

(71) Applicant: Thomas A. Brake, Abingdon, VA (US)

(72) Inventor: Thomas A. Brake, Abingdon, VA (US)

(21) Appl. No.: 15/406,736

(22) Filed: Jan. 15, 2017

(51) Int. Cl. A01K 31/04; A01K 31/14

(52) U.S. Cl. CPC A01K 31/04; A01K 31/14

(57) ABSTRACT

A nesting cavity for birds having a false floor of a screen or perforated material above a sloped floor that terminates at its lowest elevation with exposure to the exterior of the nest cavity. This exposure allows debris, water and nest parasites that fall through the false floor to exit the cavity when natural forces such as gravity act on the materials that reach the sloped floor. Increased ventilation as a result of this exposure aids in lowering moisture inside a nesting cavity and moderates a cavity temperature.

### CROSS REFERENCE TO RELATED APPLICATIONS

This application claims the benefit of provisional patent application Ser. No. 62/286,347, filed Jan. 23, 2016 by present inventor, which is incorporated by reference in its entirety.

A nesting cavity or birdhouse containing at least one or more nest building cavities. Each cavity contains a screen nest building surface or false floor that is not in direct contact with the nest cavity bottom. The nest cavity bottom is a sloped floor that terminates with exposure to the exterior atmosphere along its lowest elevation. The sloped floor allows water, parasites and nest debris that fall through the false floor, to exit the cavity through the exposure due to gravitational forces and motion from occupants and environmental forces.

The nest cavity bottom is sloped with an opening along its lowest point and can be parallel to the false floor or sloped away from one or more edges of the false floor.

Nesting cavities and birdhouses are built to dimensions and styles to suit a particular species of bird. Embodiments suitable to particular species and unique styles are envisioned.

### BACKGROUND OF THE INVENTION

The invention improves nesting cavities constructed and provided to wild birds, by humans, for the birds nesting and rearing of young.

Birding brings much joy to persons that partake in the activity. Providing nesting cavities, commonly referred to as birdhouses, to birds and observation of nesting activities is a part of birding enjoyed by many.

Nesting cavities for birds are typically constructed of a size and dimension suitable to the desired species of bird a birder is hoping to attract. These cavities are then placed in an environment suitable and attractive to that particular species. For example, the Purple Martin is a member of the swallow family and will nest gregariously in cavities of a minimum dimension of six inches by six inches by six inches, although they prefer a much larger cavity size. These houses are placed in open environments free of trees, providing the birds with an attractive location. Placing housing intended for purple martins in a wooded environment would fail to attract this specie of bird.

Suitable cavities, or houses, even though placed in a suitable environment may not always be successful attracting the desired bird or may attract undesirable bird species such as the European house finch or the European starling. Management of nest cavities by the persons that erect them should discourage occupancy by undesirable species.

Once successful attracting a target species to a nest cavity intended for that species a birder gains a sense of accomplishment and joy.

It has been found that cavities constructed for birds and commonly referred to as birdhouses, have in adequate drainage abilities. Nest cavities having floors intended for nest building that have none or few small holes drilled in the floors of them intended to provide drainage to the cavity. In practice the nest building process introduces materials into the cavity that block or plug the holes, making such holes ineffective. Moisture enters a bird nesting cavity from rain directly entering through openings intended for entrance and ventilation, from seepage under compartment doors, from condensation and from rain water shedding from the birds the cavity is intended for. Once blocked the drain holes fail to allow this moisture to leave the cavity and the nest retains water, similar to a sponge. Once soaked, a bird nest is difficult to dry and a wet nest provides a much more favorable environment for nest parasites to develop and makes it difficult for the bird species to moderate the temperature of the nest. Wet can lead to nest failure and death of the birds. As a birder that provides nesting cavities, finding birds that have perished due to these conditions is frustrating.

Attempts to address this issue have been inadequate by not addressing the cohesion of the moisture on the cavity floor and absorption of water by the debris and nesting material that can build up on a nest cavity floor.

A bird nest is a favorable habitat for bird parasites such as the blowfly to lay its eggs. Moisture from rain soaked nests creates a more favorable habitat for these eggs and the resulting larvae to develop. The larval stages of parasites such as the blowfly, feed on young birds in the nest. This feeding can result in stunted growth and death of young birds. Allowing water to drain from a nest and cavity can create a less favorable environment for development of parasites such as the blowfly. Slowing and reducing development of parasites in bird nesting cavities can yield greater nesting success for cavity nesting birds.

Parasites such as the Blowfly develop in the nests of cavity nesting birds and move onto developing young birds in the nest to feed, then return to the nest. This feeding cycle is repeated during larval development. It is common to find a population of these larvae under the nest when nests are inspected during the brood cycle of cavity nesting birds. Debris from developing birds and bird nests as well as remnants from food brought to developing brood often accumulates in the nest cavity bottom of birdhouses under the nest. This debris can hold moisture and encourage unsanitary conditions in the nest cavity of birdhouses.

Incorporating a false floor of a screen material above a sloped floor that is exposed to the exterior of a cavity provides a better way for moisture debris and parasites to be eliminated from the cavity and can decrease the negative effects of these, increasing the likelihood of successfully fledging young for the nesting birds. Having birds fledge successfully from cavities one provides increases the joy and satisfaction of birding.

### SUMMARY

In view of the above it is the object of the present invention to provide a nesting cavity floor incorporating a false floor of a whole or partial screen or perforated material, above a sloped floor with exposure to the exterior of a nest cavity along the lowest portion of the sloped floor. This exposure at the bottom of the sloped floor is to allow water and debris that should fall through the false floor, and parasites that should fall through the false floor to exit the cavity due to forces of gravity and movement within the cavity by the birds occupying the cavity as well as environmental forces such as wind on the cavity itself.

Incorporation of these improvements as components of a nesting cavity can aid inspection and maintenance of the cavity as well as aid and ease management of bird species by allowing temporary removal of components and nests during banding and inspection of nesting birds.

### BRIEF DESCRIPTION OF DRAWINGS

FIG. 1 is a view of a multi-cavity embodiment of a hygienic nesting cavity for birds, typical for gregarious nesting birds such as Purple Martins, showing a removable nest tray insert as a false floor with a partial screen bottom. These inserts comprise the screen nest building surface or false floor, in this embodiment. Each cavity contains a separate nest tray insert.

FIG. 1A shows a reduced view of a front panel of a multi-cavity structure embodiment of a hygienic nesting cavity for birds.

FIG. 2 shows an embodiment of a single hygienic nesting cavity. The false floor of this embodiment is orientated horizontally and incorporated into the birdhouse body. Other embodiments can exist where the false floor is non-horizontal or parallel to the sloped nest cavity bottom.

FIG. 2A shows an alternative embodiment of a false floor for FIG. 2 with supports for the floor created from the screen material used for the false floor. This embodiment rests on the sloped floor of the cavity.

FIG. 3 shows embodiment of a hygienic nesting cavity for birds with a false floor that is planar and sandwiched between two sections of a nesting cavity with a funnel like sloped floor that also forms the bottom of a nest cavity structure with an overall gourd like design. The false floor does not contact the nest cavity bottom except where it is co-joined with the top section of the nesting cavity. An embodiment with a contoured false floor is envisioned.

FIG. 3A shows an alternative view of the sloped floor of FIG. 3 that has an oblong exposure to the exterior of the nesting structure.

FIG. 3B shows an embodiment for the false floor of FIG. 3 having a concave form.

FIG. 4 shows an embodiment of a false floor and sloped floor forming a single component of hygienic nesting cavity. This component is envisioned as a removable component that can be exchanged with a like component during nest cavity servicing such as banding operations and routine maintenance. An embodiment wherein the component is fixed is envisioned. Variations of embodiments suitable to overall cavity design and size are envisioned. The embodiment shown in FIG. 4 shows multiple sloped surfaces being the sloped floor. Other embodiments are envisioned.

FIG. 5 shows an embodiment of the component of FIG. 4 that has a dome like sloped floor attached to the false floor of a hygienic nesting cavity.

### REFERENCE NUMBERS TO DRAWINGS

1. Nest cavity structure
2. False floor as part of nest tray insert.
3. Screen false floor
3a. Prior art
3b. Concave false floor
4. Sloped floor of nesting cavity
5. Non-screen component of a false floor
6. Nest tray side component
7. Nesting cavity
8. Cut away of nest structure side
9. Fastener for nest structure
10. Fasteners for non-screen component of false to side of nest tray.
10a. Fasteners for false floor
11. Opening showing exposure to exterior of cavity at lowest elevation of sloped floor.
12. Front panel of a multi-cavity nesting structure.
13. Entrance openings leading to interior of nesting cavities
14. Fastening openings to lock front panel to nesting structure
15. Fastening locations for funnel like sloped floor of a gourd type embodiment
16. Fastener for sloped floor
17. Nut for fastener.
18. Kerf to accept false floor
19. Removable single component including false floor and sloped floor.

### DETAILED DESCRIPTION OF THE INVENTION

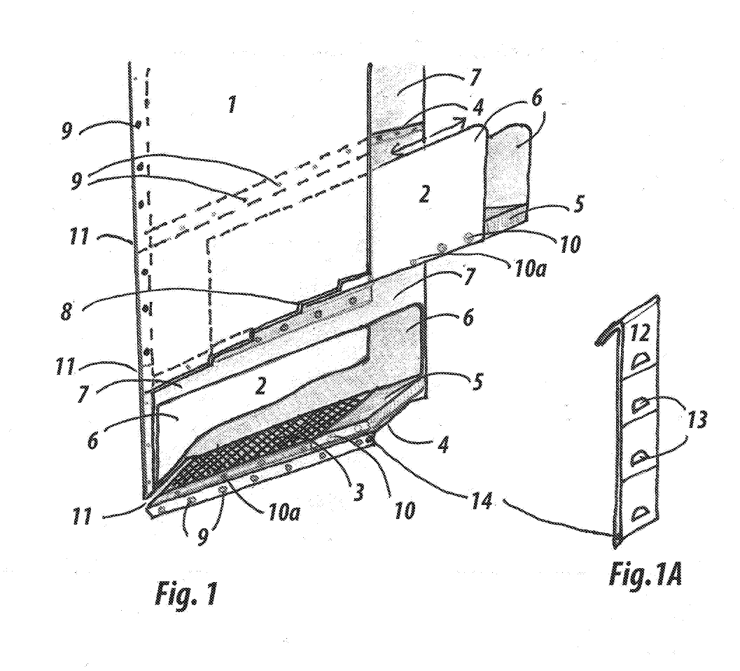

FIG. 1 shows a multi-compartment hygienic nesting cavity structure, suitable for gregarious nesting species of birds such as Purple Martins.

The nest cavity structure 1 is divided into multiple cavities 7. Each cavity 7 has an opening 11 located at the lowest point of the sloped cavity bottom 4. The opening 11 extends the width of the cavity. Each cavity 7 contains a nest tray insert 2 consisting of a nest tray front 5, three connected sides 6 and a screen nest building surface 3 also referred to as a false floor 3.

The sides 6 of the nest tray insert 2 are joined to the nest tray front 5 with fasteners 10. The false floor 3 is joined to the nest tray sides 6 with fasteners 10a. The component parts of nest cavity structure 1 are assembled with fasteners at assembly holes 9. Removable Front panel 12 is attached to birdhouse 1 at fastening hole 14. Cavity entrances 13 are cut into front panel 12.

### Operation—First Embodiment—FIG. 1

The nest cavity structure 1 is divided into multiple nesting cavities 7. Each cavity 7 contains a removable nest tray insert 2 with false floor 3 that is elevated from sloped nest cavity bottom 4. Birds build nest on the false floor 3 of nest tray insert 2.

It is common for rain to enter nesting cavities of birds through the nest cavity entrance. Current birdhouses have horizontal bottoms attached to the sides of the birdhouse with inadequate drainage. Rain that enters a birdhouse can soak nests and result in poor fledgling rates of nesting birds. This and other embodiments of a Hygienic nest cavity allow water to drain from the nest through false floor 3 and nest cavity 7 along sloped bottom 4 and exit the cavity through opening 11.

A bird nest is a favorable habitat for bird parasites such as the blowfly to lay its eggs. Moisture from rain soaked nests creates a more favorable habitat for these eggs to develop. The larval stages of parasites such as the blowfly, feed on young birds in the nest. This feeding can result in stunted growth and death of young birds. Allowing water to drain from the nest and cavity can create a less favorable environment for development of parasites such as the blowfly. Slowing and reducing development of parasites in bird nesting cavities can yield greater nesting success for cavity nesting birds.

Parasites such as the Blowfly larvae develop in the nests of cavity nesting birds and move onto developing young birds in the nest to feed then return to the nest. This feeding cycle is repeated during larval development. It is common to find a population of these larvae under the nest when nests are inspected during the brood cycle of cavity nesting birds. The screen nesting surface false floor 3 allows developing larvae to fall through the false floor 3 and fall to sloped cavity bottom 4 where forces of gravity and movement will allow them to fall from the nesting cavity 7 through cavity opening 11.

Debris from developing birds and bird nests as well as remnants from food brought to developing brood often accumulates in the nest cavity bottom of birdhouses under the nest. This debris can hold moisture and encourage unsanitary conditions in the nest cavity of birdhouses. The false floor 3 allows debris to fall to the sloped cavity bottom 4 where forces of gravity, movement and water will enable the debris to fall from the nesting cavity 7 through cavity opening 11.

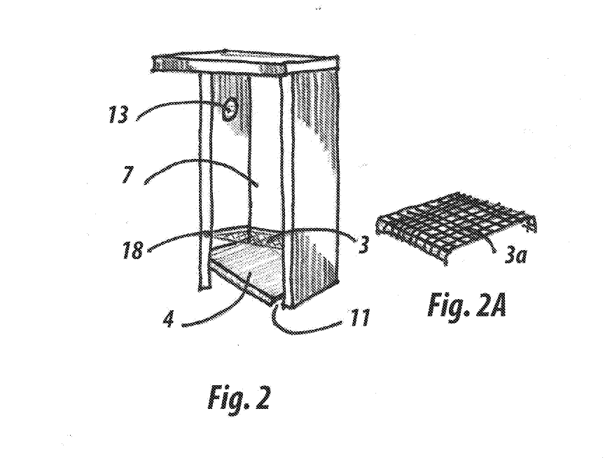

### Description—Alternative Embodiment—FIG. 2

Embodiment shown in FIG. 2 is of a single cavity birdhouse 1 with false floor 3 inserted into kerf 18 cut into interior body of birdhouse 1. Sloped nest cavity bottom 4 is sloped toward the back of birdhouse 1, but can slope toward any side or from any or multiple sides, with opening 11 extending the width of cavity structure 1. False floor 3a shows variation of false floor 3 and replaces false floor 3. False floor 3 rests on surface of sloped nest cavity bottom 4.

### Operation—Alternative Embodiment—FIG. 2

This embodiment shows a single hygienic nesting cavity.

It is common for rain to enter nesting cavities of birds through the nest cavity entrance. Current birdhouses have horizontal bottoms attached to the sides of the birdhouse oftentimes with inadequate drainage. This rain can soak nests and result in poor fledgling rates of nesting birds. This and other embodiments of a Hygienic nesting cavity for birds will allow water to drain from the nest through false floor 3 along sloped bottom 4 and exit the cavity through opening 11.

A bird nest is a favorable habitat for bird parasites such as the blowfly to lay its eggs. Moisture from rain soaked nests creates a more favorable habitat for these eggs and the resulting larvae to develop. The larval stages of parasites such as the blowfly feed on young birds in the nest. This feeding can result in stunted growth and death of young birds. Allowing water to drain from the nest and cavity can create a less favorable environment for development of parasites such as the blowfly. Slowing and reducing development of parasites in bird nesting cavities can yield greater nesting success for cavity nesting birds.

Parasites such as the Blowfly larvae develop in the nests of cavity nesting birds and move onto developing young birds in the nest to feed then return to the nest. This feeding cycle is repeated during larval development. It is common to find a population of these larvae under the nest when nests are inspected during the brood cycle of cavity nesting birds. The false floor 3 allows developing larvae to fall through the false floor 3 and fall to sloped cavity bottom 4 where forces of gravity and movement will allow them to fall from the nesting cavity 7 through cavity opening 11.

Debris from developing birds and bird nests as well as remnants from food brought to developing brood often accumulates in the nest cavity bottom of birdhouses under the nest. This debris can hold moisture and encourage unsanitary conditions in the nest cavity of birdhouses. The false floor 3 allows debris to fall to the sloped cavity bottom 4 where forces of gravity and movement and water will enable the debris to fall from the nesting cavity 7 through cavity opening 11.

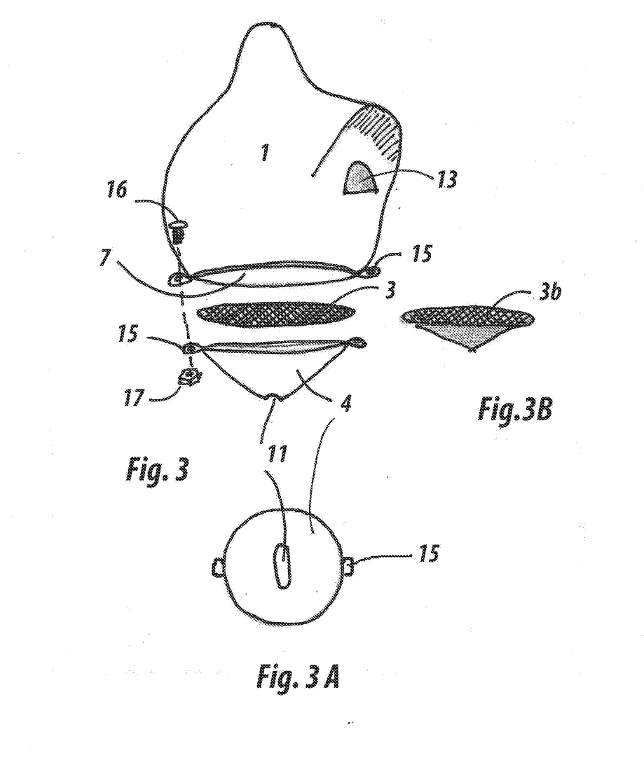

### Description—Alternative Embodiment—FIG. 3

FIG. 3 shows a gourd type Hygienic nesting cavity structure 1 with a false floor 3 that is sandwiched between gourd body 1 and sloped cavity bottom 4. False floor 3 is supported by sloped nest cavity bottom 4. False floor 3b is another embodiment of false floor that resembles the shape of sloped nest cavity bottom 4 and can replace false floor 3. Gourd body 1 and sloped nest cavity bottom 4 is joined together, sandwiching false floor 3 or 3b between them and fastened through fastening holes 15 with fasteners 16 and secured with nut 17. Nest cavity opening 11 of sloped floor 4 is at lowest part of nest cavity structure 1 after fastening. False floor 3 or 3b is only in contact with sloped floor 4 at the joining rim of sloped floor 4 and nest cavity structure 1 allowing debris, water and parasites that reach sloped bottom 4 to pass through opening 11 and exit the cavity 7.

### Operation—Alternative Embodiment—FIG. 3:

Embodiment of Hygienic nesting cavity for birds shown in FIG. 3 allows water to drain from the nest and nest cavity through false floor 3 or 3b, along sloped floor 4 and exit the cavity through opening 11.

Parasites such as the Blowfly larvae develop in the nests of cavity nesting birds and move onto developing young birds in the nest to feed then return to the nest. This feeding cycle is repeated during larval development. It is common to find a population of these larvae under the nest when nests are inspected during the brood cycle of cavity nesting birds. The false floor 3 allows developing larvae to fall through the false floor 3 and fall to sloped cavity bottom 4 where forces of gravity and movement will allow them to fall from the nesting cavity 7 through cavity opening 11.

Debris from developing birds and bird nests as well as remnants from food brought to developing brood often accumulates in the nest cavity bottom of birdhouses under the nest. This debris can hold moisture and encourage unsanitary conditions in the nest cavity of birdhouses. The false floor 3 allows debris to fall to the sloped cavity bottom 4 where forces of gravity and movement and water will enable the debris to fall from the nesting cavity 7 through cavity opening 11.

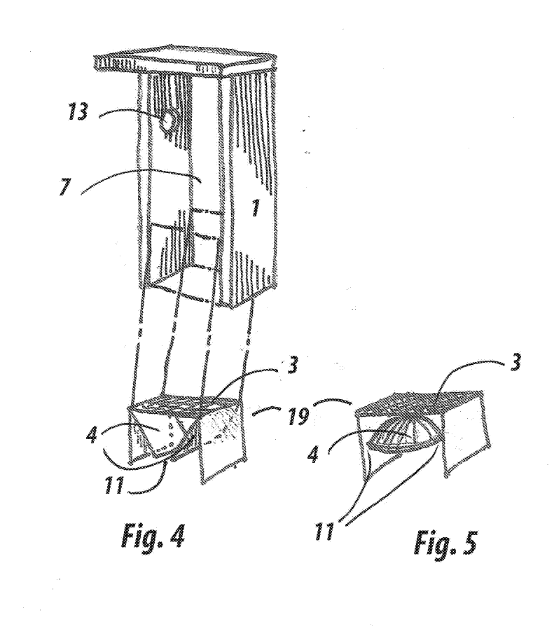

### Operation—Alternative Embodiment—FIG. 4

FIG. 4 embodiment of hygienic nesting cavity for birds shows the sloped floor 4 as a multi slope surface member of a component 19 along with false floor 3. Component 19 as a fixed or interchangeable component of nest cavity structure 1 allows water, debris and nest parasites that fall through false floor 3 to fall along surfaces of sloped floor 4 and exit the nest cavity 7 through the opening 11.

### Operation—Alternative Embodiment—FIG. 5

FIG. 5 embodiment of hygienic nesting cavity for birds shows the sloped floor 4 as a dome like member of a component 19 along with false floor 3. Component 19 as a fixed or interchangeable component of nest cavity structure 1 allows water, debris and nest parasites that fall through false floor 3 to fall along surface of sloped floor 4 and exit the nest cavity 7 through the opening 11 which follows the circumference of false floor 4.

I claim:

1. A nesting cavity for birds comprised in part of a false floor above a sloped floor wherein said sloped floor terminates at the lowest elevation of said sloped floor with exposure to the exterior of said nesting cavity and said false floor is comprised in part or in whole of a screen or perforated material.

2. The nesting cavity of claim 1 wherein said false floor is parallel to said sloped floor.

3. The nesting cavity of claim 1 wherein said false floor is non-parallel to said sloped floor.

4. The nesting cavity of claim 1 wherein said false floor is a component of a tray and said tray is able to be removed from said nesting cavity to facilitate nest inspection and maintenance.

5. The nesting cavity of claim 1 wherein said sloped floor consists of a plurality of sloped surfaces.

6. The nesting cavity of claim 1 wherein said sloped floor is funnel like.

7. The sloped floor of claim 6 that is easily removed to facilitate inspection and maintenance.

8. The nesting cavity of claim 1 wherein said cavity is a plurality composing a single structure.

9. The nesting cavity of claim 1 wherein said sloped floor is dome shape.

10. The nesting cavity of claim 1 wherein said sloped floor and said false floor form one component of said nesting cavity and said component can be removed to facilitate inspection and maintenance.

11. The nesting cavity of claim 1 wherein said false floor is concave.

12. A birdhouse including a floor with a sloped surface and a false floor above said floor wherein said floor terminates at its lowest elevation with exposure to the exterior of said birdhouse and said false floor is comprised in part or wholly of a screen or perforated material.

13. The false floor of claim 12 that is concave.

14. The birdhouse of claim 12 wherein said false floor is parallel to said floor.

15. The birdhouse of claim 12 wherein said false floor is non-parallel to said floor.

16. The birdhouse of claim 12 wherein said false floor is a component of a tray and said tray is able to be removed from said nesting cavity to facilitate nest inspection and maintenance.

17. The birdhouse of claim 12 wherein said floor consists of a plurality of sloped surfaces.

18. The birdhouse of claim 12 wherein said floor is funnel like.

19. The floor of claim 18 that is easily removed to facilitate inspection and maintenance.

20. The birdhouse of claim 12 wherein said cavity is a plurality composing a single structure.
